(19) United States
(12) Patent Application Publication
(10) Pub. No.: US 2020/0156900 A1
(43) Pub. Date: May 21, 2020

(54) COMPACT FIBER DISTRIBUTION SYSTEM

(71) Applicant: George Wakileh, Aurora, IL (US)

(72) Inventor: George Wakileh, Aurora, IL (US)

(21) Appl. No.: 16/685,530

(22) Filed: Nov. 15, 2019

Related U.S. Application Data
(60) Provisional application No. 62/768,404, filed on Nov. 16, 2018.

(51) Int. Cl. B65H 75/44; B65H 67/00; G02B 6/44

(52) U.S. Cl. CPC B65H 75/4428; G02B 6/4457; B65H 67/00

(57) ABSTRACT

A fiber distribution system includes a spool mount, a base spool rotatably secured to the spool mount, and a detachable spool coupled to an axial end of the base spool. The detachable spool is configured to be selectively removed from the base spool.

### CROSS REFERENCE TO RELATED APPLICATION

The present application claims priority from the U.S. Provisional Patent Application No. 62/768,404 filed on Nov. 16, 2018. The entirety of the disclosure of this provisional application is incorporated by reference herein.

### TECHNICAL FIELD

This application relates to fiber distribution terminals, and more particularly, to fiber distribution terminals with preinstalled fiber cable.

### BACKGROUND

In some fiber-to-the-premises applications, a fiber network terminates at a multi-unit building having a plurality of separating units needing to be connected to the fiber network. To distribute the signal transmission from a main fiber feeder cable to each separate unit of the multi-unit building, a system is conventionally used that includes a plurality of fiber devices, such as fiber distribution terminals, and fiber cables connecting the fiber devices.

When installing these systems, deploying an appropriate length of fiber cable can be a challenge with existing systems. If not enough cable is deployed, then the cable cannot reach its destination. If too much cable is deployed, the excess cable must be carefully wound into loops and stored without damaging the cable, e.g., by bending it with too tight a bend radius. Certain conventional fiber distribution systems have included integrated spools of cable that can be used to store any extra fiber cable. However, in order to ensure there is enough fiber cable on the spool, these systems have large profiles and require significant wall space.

### SUMMARY

Embodiments of the present invention include systems and methods for deploying and storing a fiber cable with a compact fiber distribution system. The fiber distribution system includes a detachable spool to provide additional fiber cable during cable deployment. Once the fiber cable has been deployed from the detachable spool, the spool can be removed. This significantly reduces the thickness of the fiber distribution system, which is of particular usefulness in tight spaces.

Fiber distribution systems according to inventive embodiments further include a spool lock that selectively locks the base spool, thereby preventing its rotation after the desired length of fiber cable has been deployed therefrom. Inhibiting rotation of the base spool with the spool lock prevents further deployment of the fiber cable, enabling the storage of any remaining cable on the base spool. This provides an easy way to store the additional fiber cable without manually winding the cable on a storage spool.

In some embodiments, a fiber distribution system can include a spool mount, a base spool rotatably secured to the spool mount, and a detachable spool coupled to an axial end of the base spool. The detachable spool can be configured to be selectively removed from the base spool.

In some aspects, a fiber distribution system configured to store a fiber cable includes a spool mount configured to be secured to the wall. The spool mount can include a hub extending outwardly from the wall. The fiber distribution system can further include a base spool rotatably received on the hub, a detachable spool secured to the base spool so that the detachable spool rotates on the hub with the base spool, and a spool lock configured to selectively impede rotation of the base spool. Further, the base spool and the detachable spool can be configured to receive the fiber cable.

In some aspects, a method of deploying fiber cable from a wall-mountable fiber distribution system can include the step of rotating a detachable spool with a base spool, unwinding the fiber cable from the detachable spool, decoupling the detachable spool from the base spool, moving a spool lock to engage the base spool, and inhibiting rotation of the base spool with be spool lock to store the fiber cable

Aspects of the invention have certain advantages. For example, the invention enables a fiber distribution system that includes long pre-installed lengths of fiber cable that can easily be deployed, and that can safely store excess fiber cable. The system has a small profile and requires only a small amount of space once the system is installed.

The foregoing and other advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a perspective view of a fiber distribution system with a spool mount, a base spool, and a spool lock;

FIG. 2 is an exploded perspective view of the fiber distribution system of FIG. 1;

FIG. 3 is a perspective view of the spool mount of FIG. 1;

FIG. 4 is a perspective view of the base spool of FIG. 1;

FIG. 5 is a perspective view of the spool lock of FIG. 1;

FIG. 6 is a perspective view of a fiber distribution system with a detachable spool;

FIG. 7 is an example image of another fiber distribution system with a detachable spool;

FIG. 8 is a perspective view of the fiber distribution system of FIG. 1 with a cassette and cable management brackets;

FIG. 9 is an exploded perspective view of the fiber distribution system of FIG. 8;

FIG. 10 is a perspective view of another fiber distribution system with a cassette and a cassette-mounted spool lock;

FIG. 11 is an exploded perspective view of the fiber distribution system of FIG. 10;

FIG. 12 is an example image fiber distribution system in a sealed enclosure;

FIG. 13 is an exploded perspective view of another fiber distribution system with a spool mount, a base spool, a spool-retaining plate, and cable management brackets;

FIG. 14 is a top-down view of the fiber distribution system of FIG. 13;

FIG. 15 is a side view of the fiber distribution system of FIG. 13;

FIG. 16 is an exploded perspective view of the fiber distribution system of FIG. 13 with a detachable spool, but without the cable management brackets;

FIG. 17 is an exploded perspective view of the fiber distribution system of FIG. 13 with a spool lock and a cassette;

FIG. 18 is an exploded perspective view of the spool lock and cassette of FIG. 17;

FIG. 19 is a top-down view of the spool lock and cassette of FIG. 17;

FIG. 20 is a side view of the spool lock and cassette of FIG. 17;

FIG. 21 is an exploded perspective view of the fiber distribution system of FIG. 13 with an enclosure;

FIG. 22 is an exploded perspective view of the fiber distribution system of FIG. 16 with an enclosure; and

FIG. 23 is a process flow chart of a method of deploying and storing a fiber cable.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Disclosed herein is a compact fiber distribution system for deploying and storing a fiber cable. In some embodiments, the fiber distribution system can include a spool mount, a base spool that is coupled to—and permitted to rotate on—the spool mount, and a detachable spool removably coupled to the base spool. A continuous fiber cable can be spooled on the base spool and the detachable spool such that the fiber cable can be unwound therefrom and deployed by rotating the base spool and the detachable spool. Once the fiber cable is completely unwound from the detachable spool, the detachable spool can be decoupled from the base spool and removed, thereby reducing the profile of the fiber distribution system.

In some embodiments, a fiber distribution system can include a spool lock adapted to selectively inhibit rotation of the base spool once the required length of fiber cable is deployed, thereby providing storage for the unused fiber cable. Furthermore, in some embodiments, a cassette can be coupled to a DIN rail on fiber distribution system. The fiber distribution system can also include cable management brackets configured for attachment to the base spool, and further to limit the bend radius of a portion of the fiber cable.

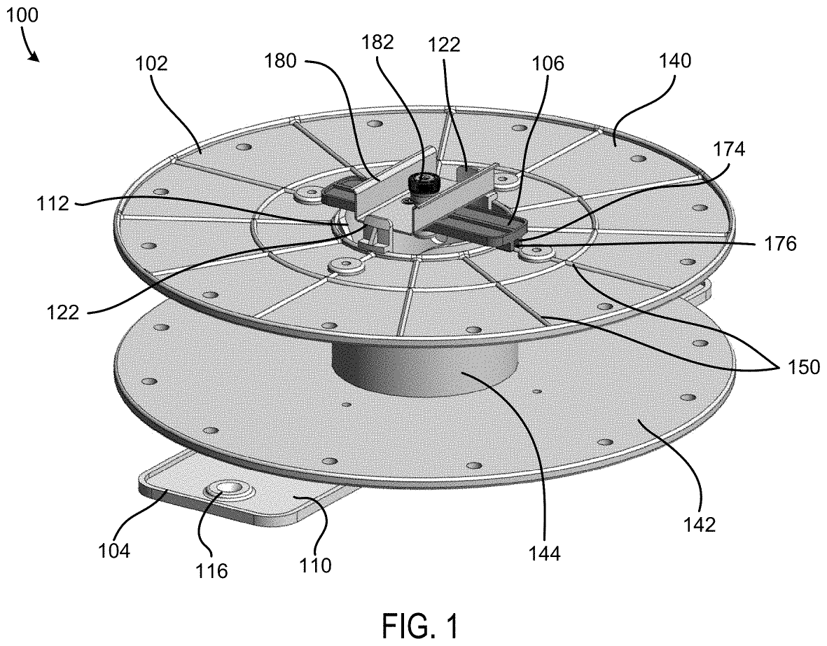

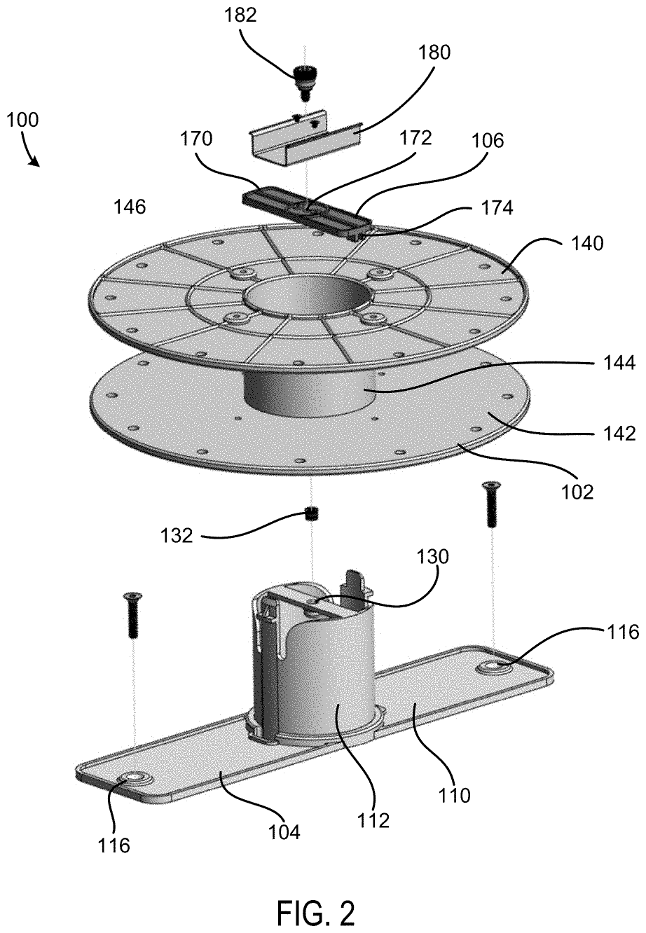

Referring now to the figures, and in particular FIGS. 1 and 2, an exemplary embodiment of a fiber distribution system 100 is illustrated. The fiber distribution system includes a base spool 102 rotatably secured to a spool mount 104 and a spool lock 106 configured to selectively inhibit rotation of the base spool 102 with respect to the spool mount 104.

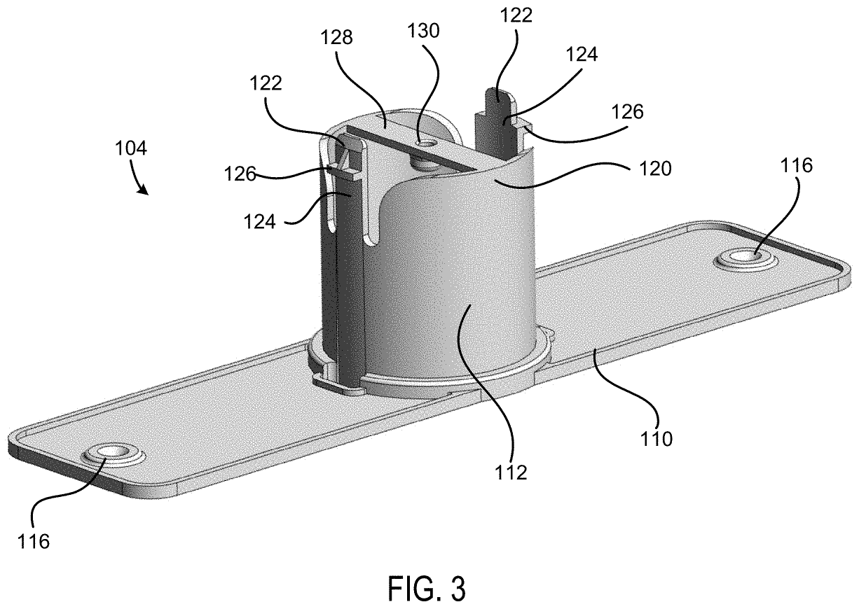

As illustrated in FIG. 3, the spool mount 104 includes a base plate 110 and a hub 112 protruding outwardly from the base plate 110. The base plate 110 can include one or more mounting features, such as two mounting openings 116, configured to receive a fastener 118 to secure the spool mount 104 to a mounting surface, such as an interior wall within a building or a surface within an electrical box. In some embodiments, a mounting feature other than an opening can be included. For example a mounting feature could be a protrusion configured to engage an opening in a mounting surface, or a latch configured to engage a hook on the mounting surface. Additionally, some embodiments can include the same or a different number of mounting features as the illustrated embodiment, such as one, three, four, five, or more mounting features.

The hub 112 has a substantially circular cross section and extends from the base plate 110 to an attachment end 120 of the hub 112. The attachment end 120 can include one or more spool retainers 122, such as two spool retainers 122, arranged around the circumference of the hub 112. Each spool retainer 122 includes a vertical finger 124 extending away from the base plate 110 and a horizontal latch 126 protruding radially outward from the vertical finger 124 such that the horizontal latch 126 is substantially parallel to the base plate 110. The vertical fingers 124 are semi-rigid and can flex radially inward without breaking or permanently deforming. The attachment end 120 further includes an attachment surface 128 facing away from the base plate with a hub opening 130 formed centrally therein.

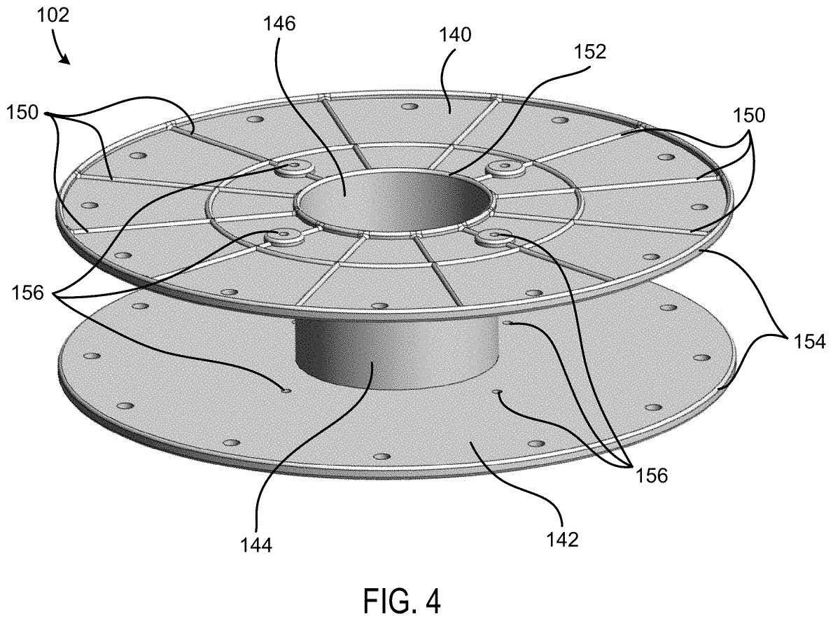

Referring to FIG. 4, the base spool 102 includes a first axial end 140, a second axial end 142 opposite the first axial end 140, and a spooling portion 144 disposed between the first and second axial ends 140, 142. The spooling portion 144 is configured to receive a fiber cable by wrapping at least a portion of the fiber cable around the spooling portion 144 (see, e.g. FIG. 7). In the illustrated embodiments, the first axial end 140 and the second axial end 142 each have a larger diameter than the spooling portion 144, thereby inhibiting axial movement of the fiber cable off of the spooling portion 144. However, in some embodiments, a first axial end may have a larger or smaller diameter than a second axial end. In some embodiments, a base spool can include only one axial end with a diameter larger than that of a spooling section. In another embodiment, both of the axial ends may be the same diameter as the spooling portion of a base spool.

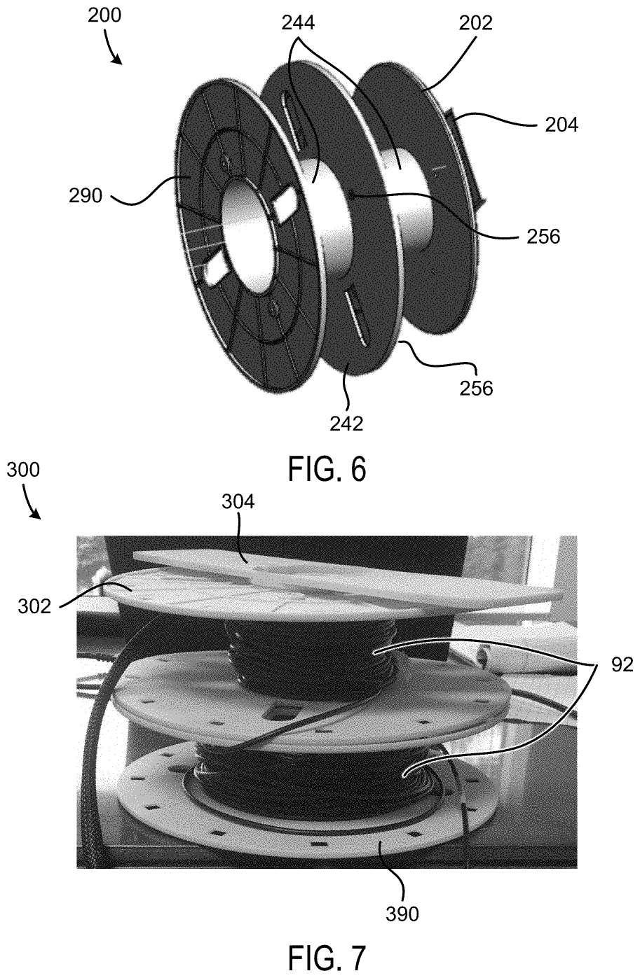

The base spool 102 further includes a central passage 146 defined by the hollow interior of the spooling portion 144 and extending from the first axial end 140 to the second axial end 142. The first and second axial ends 140, 142 of the base spool 102 can include a plurality of locking features, such as ridges 150, arranged around the central opening 152. Each one of the ridges 150 extends radially outward from the central opening 152 to a distal edge 154 of the axial ends 140, 142. The first and second axial ends 140, 142 can also include one or more coupling features, such as four coupling openings 156, arranged around the central opening 152 and extending through the respective one of the first axial end 140 or the second axial end 142. Usefully, and as discussed in greater detail with respect to FIGS. 6 and 7, the coupling openings 156 can correspond to coupling openings on a detachable spool, enabling the selective attachment of the detachable spool to the base spool 102.

In some embodiments, the at least one of the coupling openings 156 or the ridges 150 can be formed on the first axial end but not on the second axial end 142. Similarly, the central opening 152 can be formed in only the second axial end 142. Further, some embodiments may include at least one locking feature that is different than those in the illustrated embodiments. For example, an embodiment can include ridges that only partially extend from a central opening to a distal end. In another embodiment, one or more of the locking features could be a peg or a stud. Further still, some embodiments can include more or less locking features and/or coupling openings than the illustrated embodiments. For example, an axial end could include one, two, three, four, five or more coupling openings or ridges.

Looking to FIGS. 1-2 and 4, the central passage 146 is sized so that the base spool 102 can be received on and freely rotate about the hub 112. Once received on the spool mount 104, the horizontal latch 126 of the spool retainers 122 restricts axial movement of the base spool 102 on the hub 112, thereby securing the base spool 102 to the spool mount 104. The base spool can be released by flexing the vertical fingers 124 inward to move the horizontal latches 126 inside the diameter of the central passage 146. In some embodiments, a base spool can be secured to a spool mount using a different attachment system. For example, a fastener could be configured to engage corresponding openings on the base spool and the spool mount, or the base spool could include a shaft configured to be rotatably received by the spool mount. Further, in some embodiments where a base spool only includes one large axial end, the base spool can be received on a spool mount so that a portion of the spool mount, such as a base plate, can restrict axial motion of a fiber cable on said spool mount.

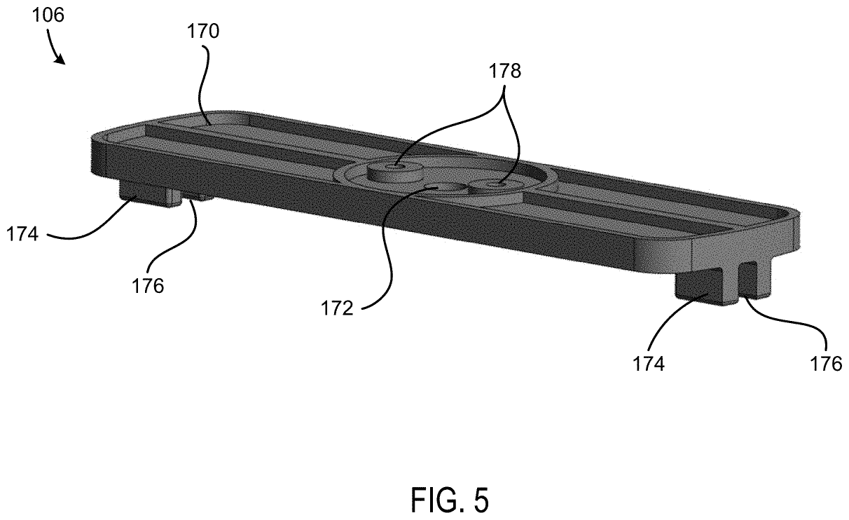

Referring now to FIG. 5, the spool lock 106 includes a lock body 170 with a centrally positioned lock opening 172 extending through the lock body 170. Two stop members 174 protrude from the lock body 170 and are positioned at opposite distal ends of thereof. Each stop member 174 includes a recess 176 formed in a side of the stop member 174 opposite the lock body 170. Further, two rail openings 178 are formed in the lock body 170 and are configured to receive a fastener to secure a DIN rail 180 to the spool lock 106. In some embodiments, a DIN rail can be coupled to a spool lock with an adhesive or through any other suitable method of attachment. A DIN rail can also be coupled to a different part of the fiber distribution system, such as the base spool of the spool mount.

Looking back to FIGS. 1 and 2, a thumb screw 182 is configured to engage the lock opening 172 and the hub opening 130, thereby securing the spool lock 106 to the spool mount 104. In some embodiments, a threaded insert 132 can be received in the hub opening 130 and can facilitate the connection between the thumb screw 182 and the spool base. Conversely, a thumb screw can directly interface with a hub opening in some embodiments. Further, a different fastener can be used as an alternative to a thumb screw. For example, a screw, a bolt, or any other suitable fastener can be used.

The thumb screw 182 can be tightened or loosened to move the spool lock 106 into an unlock state or a locked state, respectively. In the unlocked state, the spool lock 106 can rotate freely about the thumb screw 182 and move axially toward or away from the base spool 102. The base spool 102 is also permitted to freely rotate about the hub in both directions. In the locked state (see, e.g. FIG. 1), the thumb screw 182 pushes the spool lock 106 towards the base spool 102 so that the stop members 174 are in contact with the first axial end 140, and so that movement and rotation of the spool lock 106 is restricted. The spool lock 106 can be oriented so that, in the locked state, the stop members 174 are in contact with the surface of the first axial end 140 between two of the ridges 150, or so that at least one stop member 174 engages one of the ridges 150 by receiving said ridge 150 in the recess 176. When the stop members 174 are between two of the ridges 150, rotation of the base spool in either direction will bring at least one of the stop members 174 into abutment with one of ridges 150, thereby preventing further rotation in that direction. When at least one stop member 174 is engaged with a ridge 150, the base spool 102 is inhibited from rotation in either direction.

As previously mentioned, some embodiments of a fiber distribution system can include a detachable spool configured to be coupled to a base spool. For example, FIG. 6 illustrates a fiber distribution system 200 including a base spool 202 that is received on a spool mount 204 and a detachable spool 290 secured to the base spool 202. Fasteners are engaged with two coupling openings 256 formed in the first axial end 240 of the base spool 202 and two corresponding coupling openings 256 formed in the second axial end 242 of the detachable spool 290. Because it is rigidly connected to the base spool 202, the detachable spool 290 can rotate with the base spool 202. The detachable spool 290 can be decoupled and removed from the base spool 202 by removing the fasteners that are in engagement with the coupling openings 256.

As illustrated in FIG. 7, a fiber distribution system 300 can include a base spool 302 a detachable spool 390 configured to receive a fiber cable 92. The fiber cable 92 is continuously would around the respective spooling portions of the base spool 302 and the detachable spool 390. In some embodiments, however, separate fiber cables may be spooled on each of the spooling portions. The fiber distribution system 300 is configured so that rotation of the spools 302, 390 about the hub 340 in a first direction can unwind and deploy the fiber cable 92 from the base spool 302 and rotation in a second direction can unwind and deploy the fiber cable 92 from the detachable spool.

Some embodiments can include more than one detachable spool. For example, a first detachable spool can be coupled to a base spool, a second detachable spool can be attached to the first detachable spool opposite the base spool, and a third detachable spool can be similarly coupled to the second detachable spool.

Further, in some embodiments, a base spool or a detachable spool can include at least one coupling feature that is different than those in the illustrated embodiments. For example, a detachable spool and/or a base spool can include at least one of a peg, a clip, a hook, or a different protrusion that is configured to engage an opening, a peg, a clip, a hook, or any other coupling feature on the other one of the base spool or the detachable spool. Further, in some embodiments, only one of a base spool or a detachable spool can include a coupling feature. For example, a detachable spool or a base spool can include a clip configured to engage a distal edge of an axial end of the other spool.

Some embodiments can also include a detachable spool that has other differences from a base spool. For example, a detachable spool can more ridges than the base pool, less ridges than the base spool, or no ridges. A detachable spool can also have a central passage with a larger or smaller diameter than a base spool. For example, a detachable spool can have a central passage that is large enough to fit around a spool lock while it is attached to a spool mount, enabling the detachable spool and the spool lock to be simultaneously attached to the system.

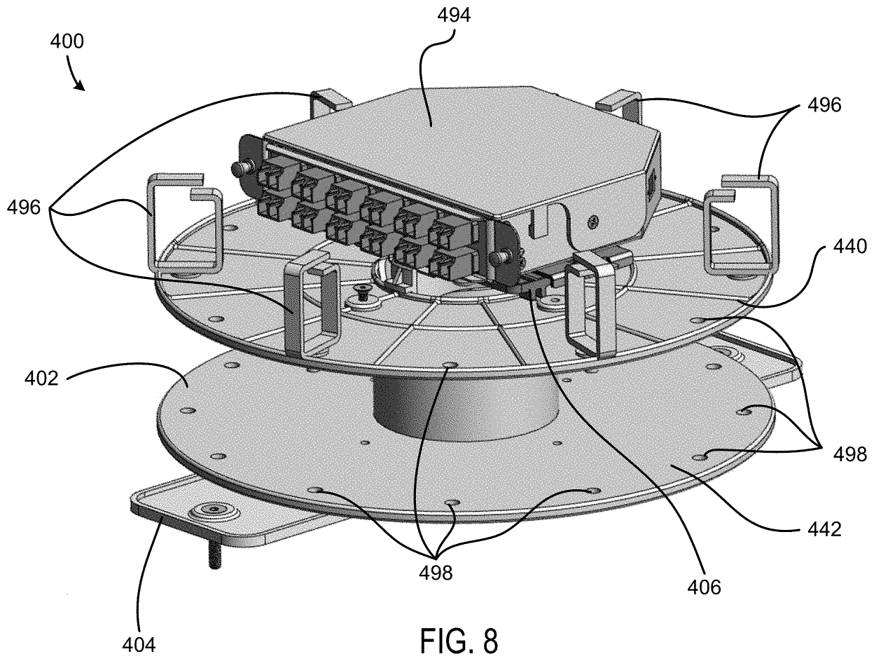

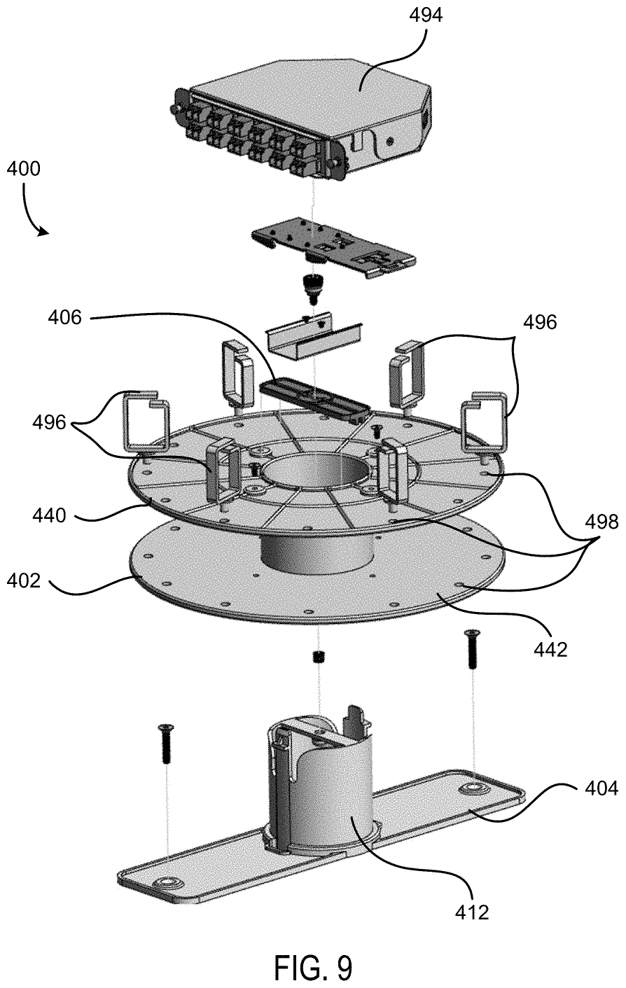

Some embodiments of a fiber distribution system can include additional elements. As illustrated in FIGS. 8-9, for example, a fiber distribution system 400 can include a network feature, such as a cassette 494, configured to be coupled to the DIN rail 480. In some embodiments, other network elements can be used. The fiber distribution system 400 can also include a one or more cable management features, such as cable management brackets 496. The cable management brackets 496 can be received by openings 498 formed in the first or second axial ends 440, 442 of a base spool 402, and are configured to limit the bend radius of a fiber cable coupled to the system 400. In some embodiments, cable management brackets may be coupled to a different part of a fiber distribution system, such as a spool mount. Further, in some embodiments, cable management brackets can be integrated into a base spool or spool mount. For example, a cable management bracket could be integrally formed in a base spool and foldable between a folded position where the bracket is flush with an axial end of the spool, and an unfolded position where the bracket protrudes from the axial end.

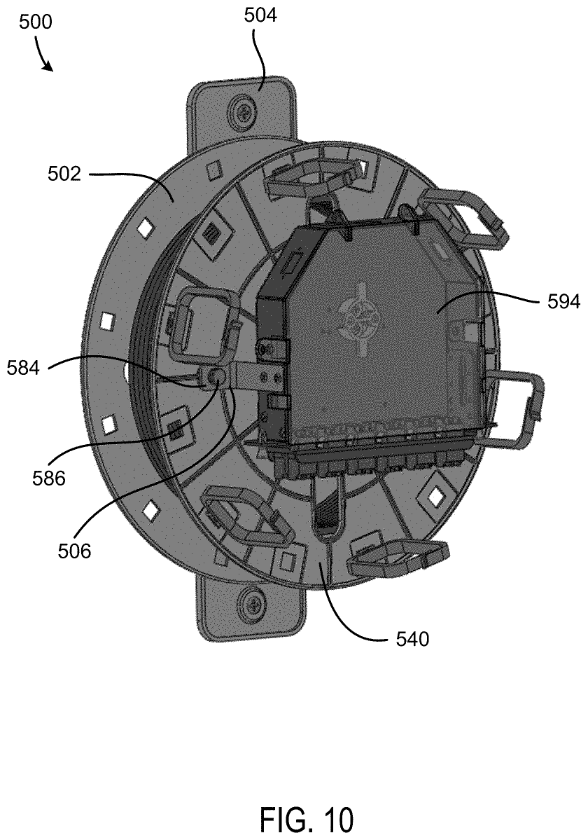

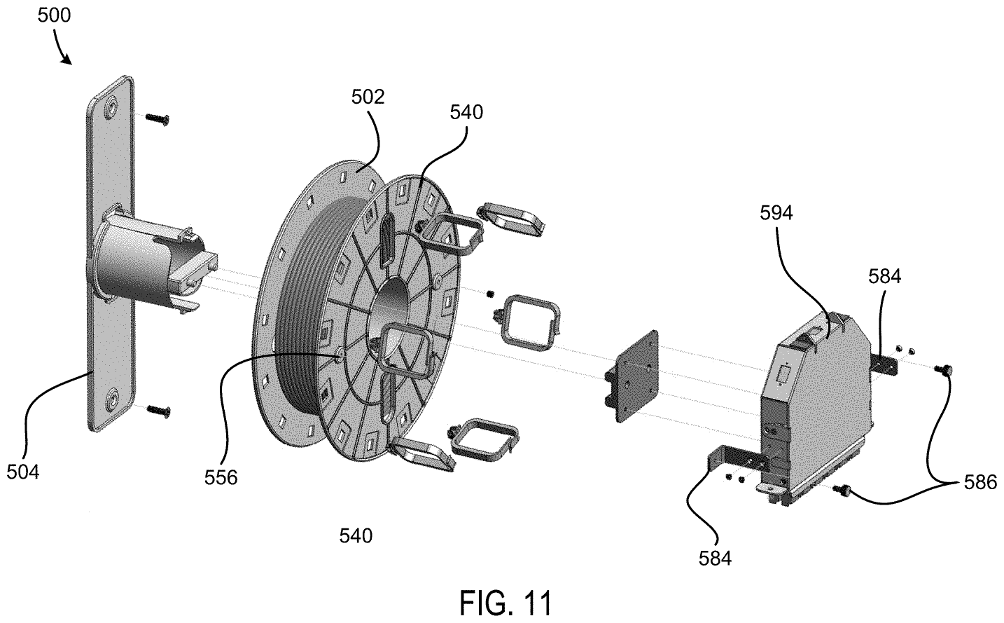

Additional variations of a fiber distribution system are also possible. As illustrated in FIGS. 10-11, for example, a fiber distribution system 500 can have a spool lock 506 including a bracket 584 configured to be coupled to the cassette 594 and an adjustable stop 586 movably coupled to the bracket 584. The adjustable stop 586 can be moved to engage one or more of the coupling opening 556 formed the first axial end 540 of a base spool 502. The adjustable stop 586 can also be moved to engage a surface of the first axial end 540 to restrict or inhibit rotation of the base spool 502. In some embodiments, a base spool can include a separate opening configured to be engaged by the adjustable stop 586. Further, a base spool can include other features configured to be engaged by a movable stop. For example, a base spool can include a plurality slots formed in an axial end and extending from a central region to a region proximate the distal ends of the base spool.

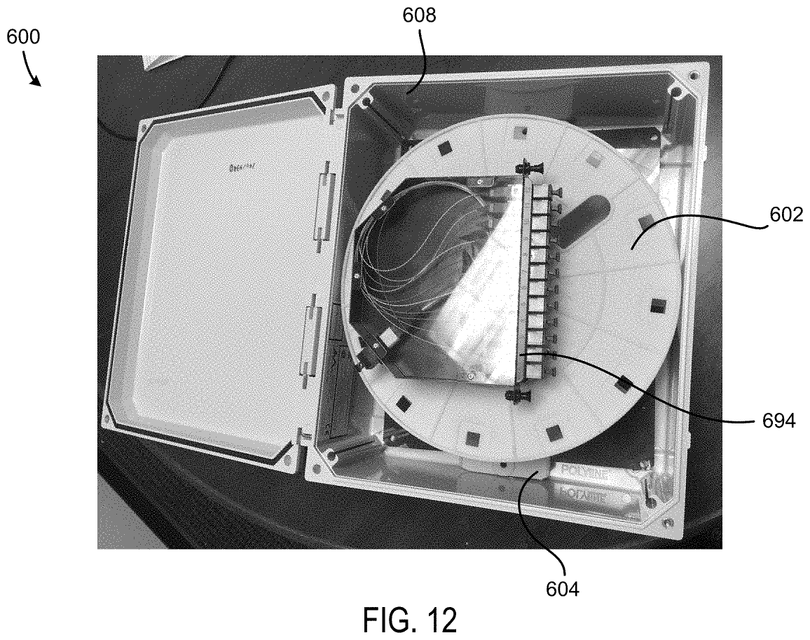

As illustrated in FIG. 12, embodiments of a fiber distribution system 600 can include an enclosure 608 that is sized to receive the spool mount 604 and the base spool 602 with an attached spool lock and cassette 694. The enclosure 608 can be wall mountable and selectively sealable to protect the enclosed fiber cable and network elements. In some embodiments, an enclosure can include one or more openings to allow fiber cables to enter or exit the enclosure. Enclosures can also be configured with different environmental protection ratings or different features, such as electrical isolation or watertightness.

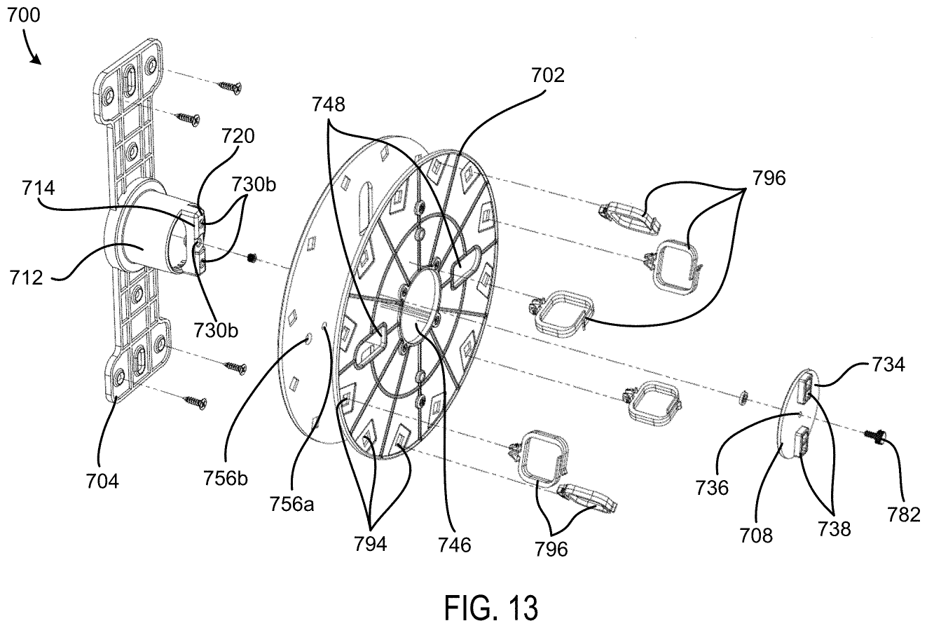

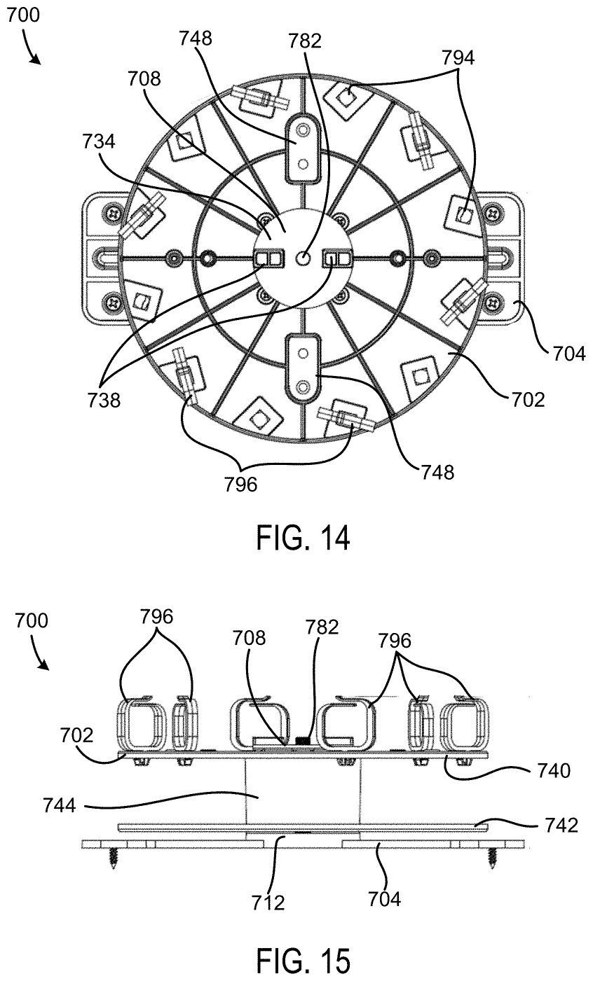

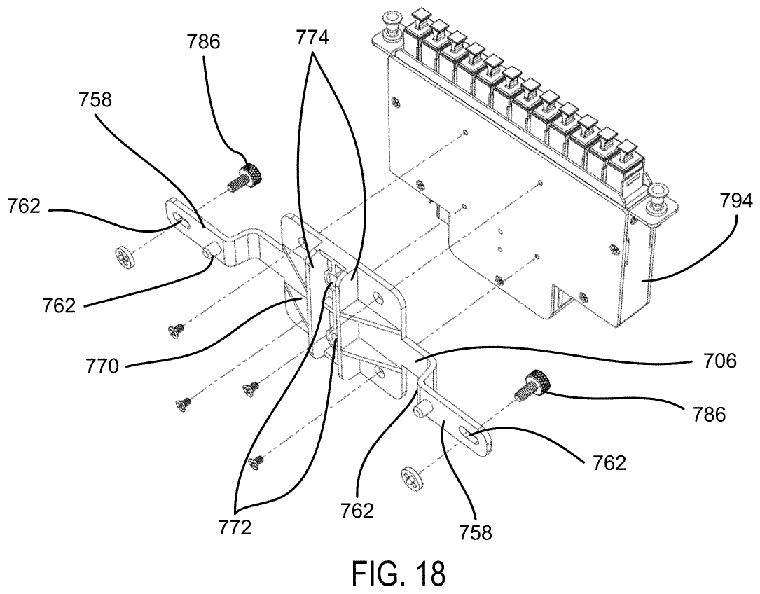

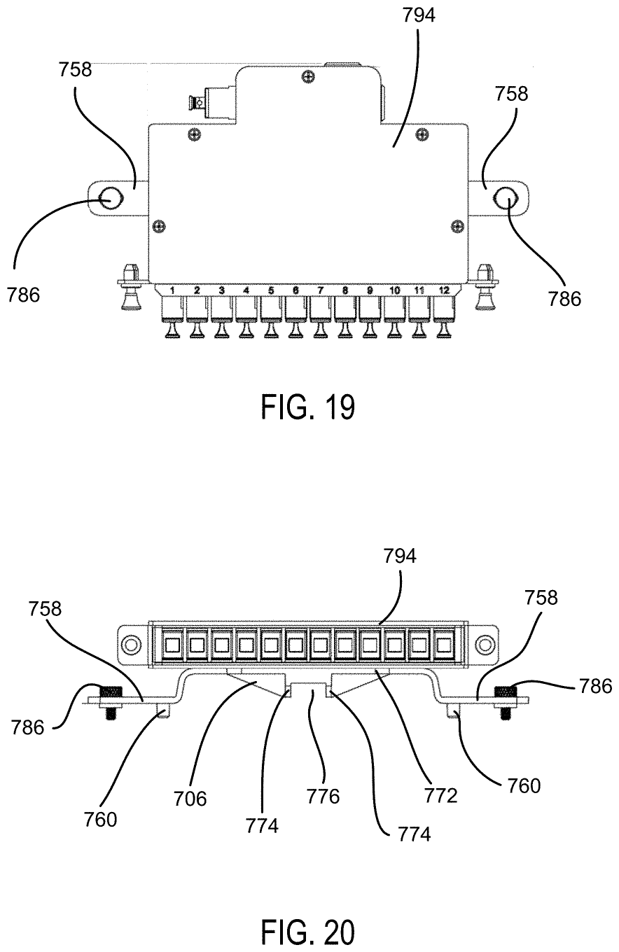

As illustrated in FIGS. 13-22, embodiments of a fiber distribution system 700 can include a spool-retaining plate 708 configured to retain a base spool 702 on a spool mount 704. Looking to FIGS. 13-15 in particular, the spool-retaining plate 708 includes a plate body 734 that is a generally planar disk with a circular cross section and has a plate opening 736 formed through the center of the plate body 734. Further, two raised blocks 738 protrude from the plate body 734 and are positioned at opposite distal ends thereof. The spool mount 704 can include a hub ridge 714 formed on the attachment end 720 of the hub 712, and three hub openings—a central hub opening 730a and two peripheral hub openings 730b—formed in the hub ridge 714. A fastener 782 can be configured to engage the plate opening 736 and the central hub opening 730a, thereby securing the spool-retaining plate 708 to the attachment end 720 of the hub 712. In the illustrated embodiment, the hub 712 and the hub ridge 714 are dimensioned so that, when the base spool 702 is received on the spool mount 704, the hub ridge 714 extends through the central passage 746 and past the first axial end 740 of the base spool 702. Additionally, the diameter of the plate body 734 is larger than the diameter of the central passage 746 of the base spool 702. In this way, the spool-retaining plate 708 can secure the base spool 702 on the spool mount 704 while allowing the base spool 702 to rotate on the hub 712.

In some embodiments, a spool-retaining plate can include a plate body with a different shape. For example, the plate body could have at least one of a parallelogram, triangular, or a differently shaped cross section. A plate body can also be non-planar and/or have a thickness that is larger or smaller than the illustrated embodiment. In some embodiments, a spool-retaining plate may have at least one peripheral opening corresponding to a peripheral opening on the hub. For example, a spool-retaining plate could have two peripheral openings corresponding to two peripheral openings formed in the hub, and a fastener can be configured to engage at least one pair of corresponding peripheral openings. Further still, at least one feature may be omitted from a spool mount or a spool-retaining plate. For example, an embodiment of a fiber distribution system can omit at least one of the hub ridge, the central hub opening, one or both of the peripheral hub openings, the plate opening, or one or both of the raised blocks.

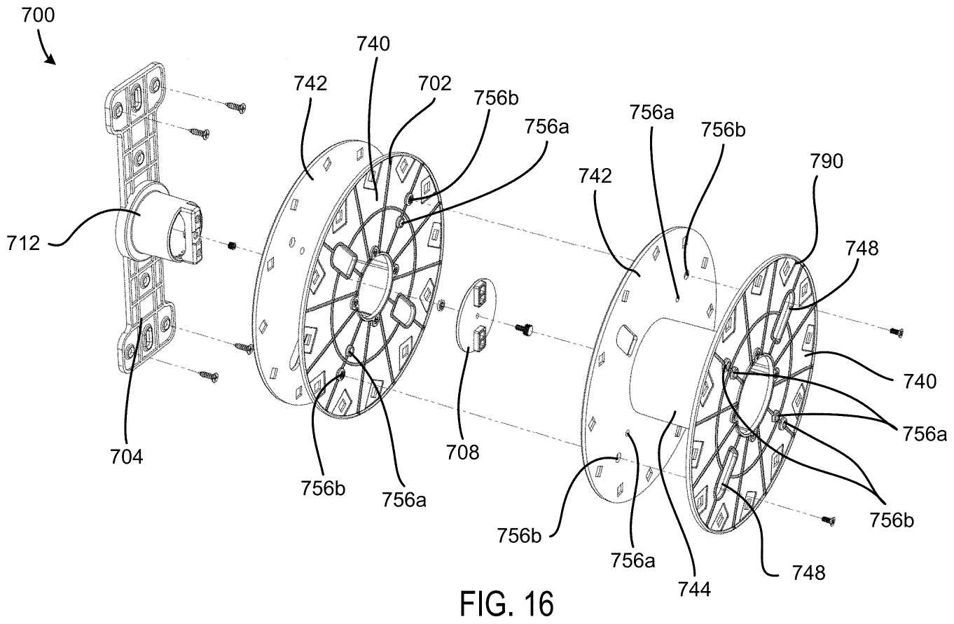

Looking to FIGS. 13-16, at least one of a base spool or a detachable spool can be modular spools including multiple components. In the illustrated embodiment, for example, the base spool 702 and the detachable spool 790 include first axial ends 740, second ends 742, and spooling portions 744 that are all detachable and can be selectively coupled to each other with at least one fastener. Different sizes and configurations of the axial ends 740, 742 and the spooling portions 744 can be used according to the specific circumstances in which the fiber distribution system 700 is utilized. Each of the first and second axial ends 740, 742 can include access slots 748 configured to be aligned with the coupling openings 756a, 756b formed in the opposite axial end 740, 742. As shown in FIG. 16, access slots 748 formed in the first axial end 740 of the detachable spool 790 provide access to the coupling openings 756, 756b on the second axial end 742. This configuration contributes to the ease of coupling the detachable spool 790 to the base spool 702. The axial ends 140, 142 can also include cable management openings 798 which are configured to hold the cable management brackets 796 at an angle offset from the center of the base spool 702 or the detachable spool 790. As illustrated in FIGS. 13-15, for example, the cable management brackets 796 are each angled towards an adjacent cable management bracket 796.

In some embodiments, a fiber distribution system can include at least one modular spool and at least one unitary spool. For example, a fiber distribution system can have at least one of a base spool or a detachable spool with a modular design having multiple pieces and at least one of a base spool or a detachable spool with a unitary design. Further, at least one axial end can be different than at least one other axial end. For example, at least one axial end of a base spool can omit at least one access slot and at least one axial end of the detachable spool can omit at least one cable management opening. In one example, at least one cable management openings can be a different shape or in a different orientation that at least one of the other cable management openings.

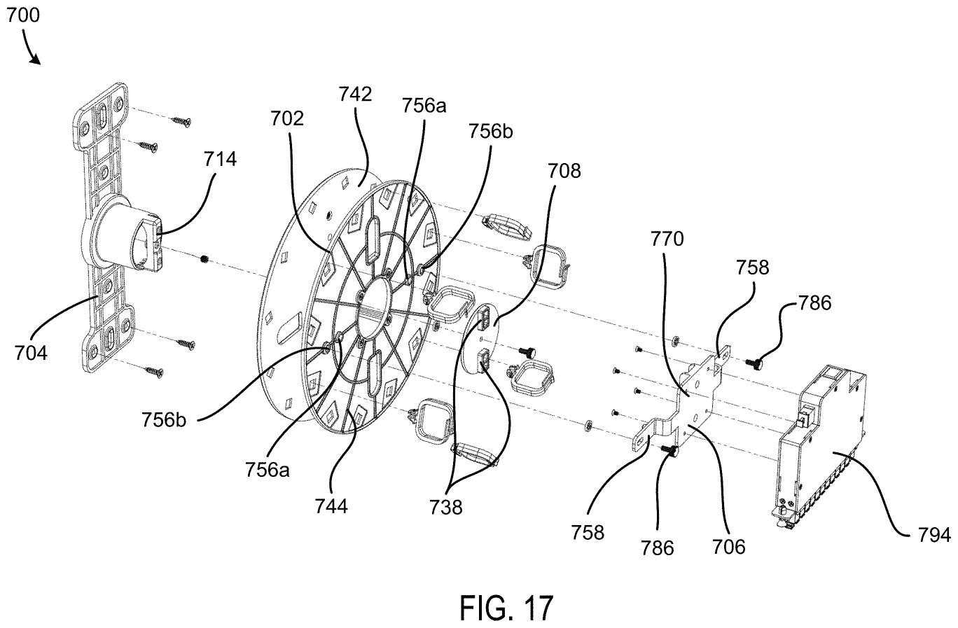

Turning now to FIGS. 17-20, the fiber distribution system 700 can include a spool lock 706 configured to be coupled to a cassette 794. The spool lock 706 can include a lock body 770 configured to be selectively secured to the cassette 794 with at least one fastener. Two stop members 774 extend from a side of the lock body 770 opposite the cassette 794 and are positioned on opposite sides of two lock openings 772 formed through the lock body 770. The space between the two stop members 774 defines a recess 776 which extends across the lock body 770. The spool lock 706 further includes two brackets 758 extending from opposite sides of the lock body 770. Each bracket 758 includes a lock peg 760 projecting outward in the same direction as the stop members 774, and a bracket opening 762 formed through the bracket 758 and configured to receive a thumb screw 786, or another type of fastener or adjustable stop.

As shown in FIG. 0.17, when the spool lock 706 is positioned on a base spool 702 secured to a spool mount 704 with a spool-retaining plate 708, the lock pegs 760 are received in a first set of coupling openings 756a on the base spool and the thumb screws 786 engage a second set of coupling openings 756b, thereby securing the spool lock 706 and the cassette to the base spool 702. When the spool lock 706 is coupled to the base spool 702, the two raised blocks 738 on the spool-retaining plate 708 can be received in the recess 766 between the stop members 174, thereby restricting rotation of the base spool 702. In another locking configuration, the spool-retaining plate can be omitted and a fastener can be configured to engage the lock openings 772 of the spool lock and the peripheral hub openings 730b on the hub 712, thereby securing the spool lock 706 directly to the spool mount 704. When the base spool 702 is received on the hub 712, the lock pegs 760 engage a corresponding set of coupling opening 756a to restrict rotation of the base spool 702.

In some embodiments, other locking configurations can be used. For example, a spool lock can include one lock opening and a fastener configured to be engage the one lock opening and the central hub opening, thereby securing the spool lock to the spool mount. In this example, the hub ridge can be received in the recess between the stop members to restrict rotational motion between the spool lock and the spool mount, and consequently restricting the rotation of the base spool. Further, some embodiments may include additional features or omit features included in the illustrated embodiments. For example, some embodiments of the spool lock may not include at least one stop member or at least one lock opening.

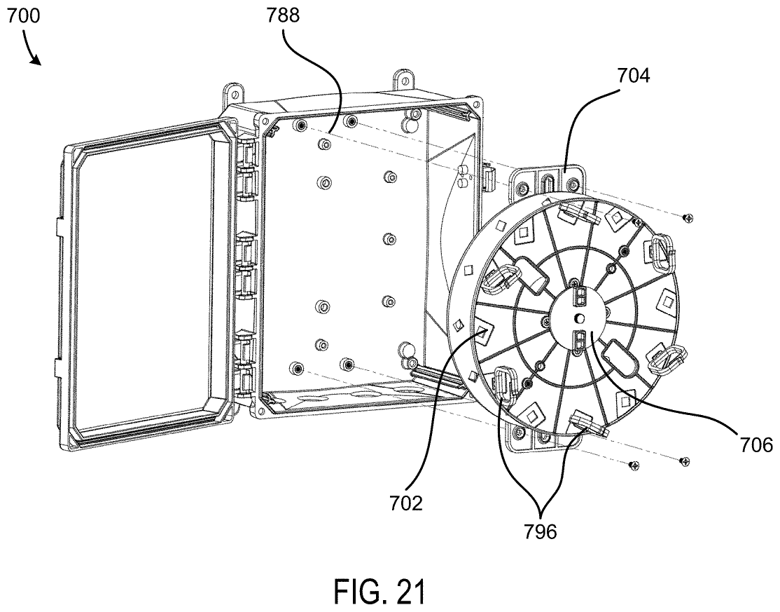

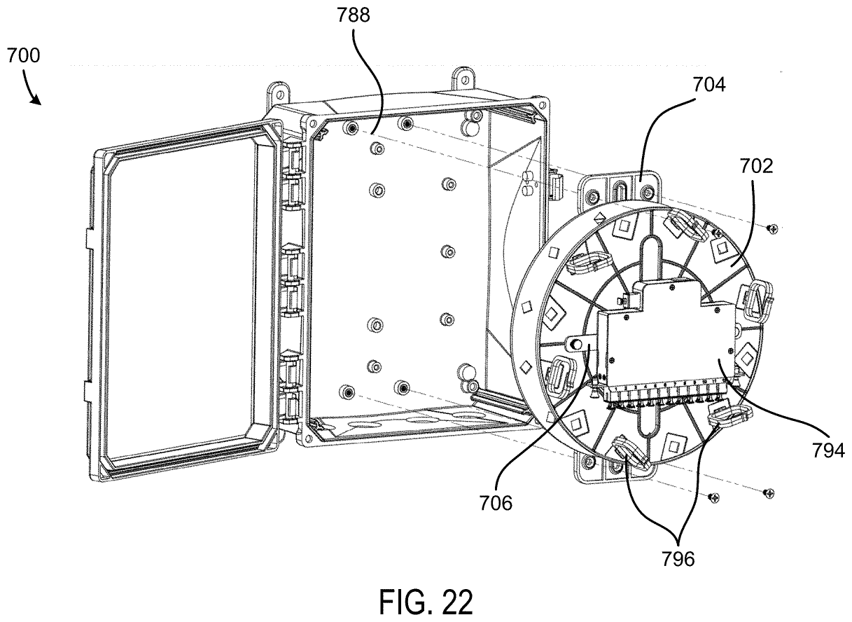

As illustrated in FIGS. 21-22, an enclosure 788 can be configured to receive the spool mount 704, the base spool, 702, and the spool-retaining plate 708. The enclosure 788 may also be configured to receive additional components including, for example, at least one cable management bracket 796, the spool lock 706, or the cassette 794. In some embodiments, an enclosure may be configured to house still other components, such as a detachable spool.

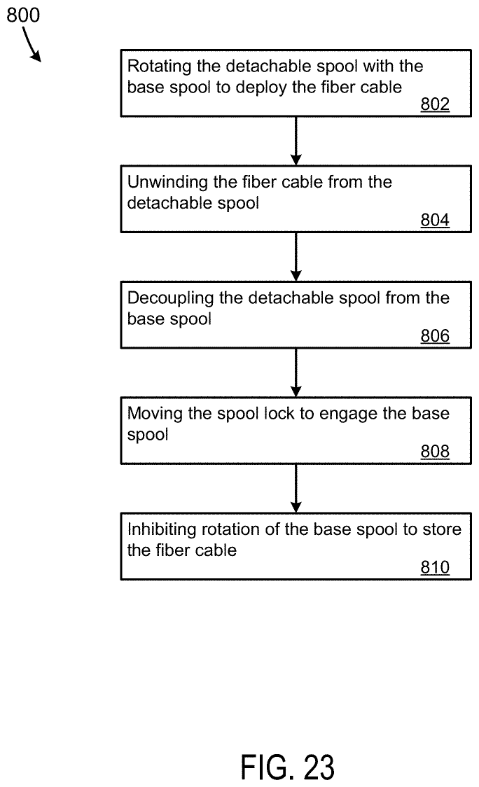

Referring now to FIG. 23, a method 800 of deploying and storing a fiber cable using a fiber deployment system is illustrated as a process flow chart. First, the step of rotating the detachable spool with the base spool is performed in process block 802. As the base spool and the detachable spool are rotated, the fiber cable stored on the spools is deployed. The deployment of the fiber cable is continued in process block 804, which includes the step of unwinding the fiber cable from the detachable spool. As the detachable spool is rotated and fiber cable is deployed therefrom, the fiber cable is unwound from a spooling portion of said detachable spool.

Once the fiber cable is completely unwound from the detachable spool, the step of decoupling the detachable spool from the base spool is performed in process block 806. Removal of the detachable spool significantly reduces the thickness of the fiber deployment system's profile. Once removed from the fiber distribution system, the detachable spool can be discarded or saved for reuse. Following the removal of the detachable spool, the spool lock can be moved to engage the base spool in process block 808. In the locked state, the spool lock can engage a surface of the base spool or at least one locking feature on the base spool.

After the spool lock has engaged the base spool, the step of inhibiting rotation of the bas spool, thereby storing the fiber cable spooled on the base spool, is performed in process block 810. In this step rotation of the base spool can be restricted to a limited range or prevented all together. By inhibiting rotation of the base spool further deployment of the fiber cable is prevented.

In some embodiments, a method of using a fiber distribution system can include additional steps. For example, so methods include a step of rotating the base spool after the detachable spool has been decoupled therefrom. This continued rotation of the base spool may further deploy a fiber cable by unwinding the cable from the base spool. Further, some embodiments can include a step of securing the spool lock to the spool mount. In other embodiments where the spool lock is pre-attached, this step can be omitted. Further still, some embodiments can include a step for attaching a network element to the fiber distribution system. For example, a method may include the step of coupling a cassette to the spool mount, or to a DIN rail on the fiber distribution system.

1. A fiber distribution system comprising:
a spool mount;
a base spool rotatably secured to the spool mount;
a detachable spool coupled to an axial end of the base spool; and
wherein the detachable spool is configured to be selectively removed from the base spool.

2. (canceled)

3. The fiber distribution system of claim 1, further comprising: a retention plate secured to the hub and configured to retain the base spool on the hub.

4. The fiber distribution system of claim 3, further comprising a spool lock configured inhibit rotation of the base spool when the spool lock abuts the retention plate.

5. The fiber distribution system of claim 1, further comprising a DIN rail and a fiber network element configured to be secured to the DIN rail.

6. (canceled)

7. The fiber distribution system of claim 1, further comprising a spool lock configured to inhibit rotation of the base spool when the spool lock is in a locked state and to allow rotation of the spool when the spool lock is in an unlocked state.

8. The fiber distribution system of claim 7, wherein the base spool includes one or more openings formed in the axial end; and
wherein the spool lock is configured to selectively engage one of the openings.

9. The fiber distribution system of claim 7, wherein the base spool includes one or more locking features protruding outwardly from the axial end; and
wherein the spool lock is configured to engage at least one of the locking features or a surface of the axial end between two of the locking features.

10. The fiber distribution system of claim 7, wherein the spool lock is configured to be selectively secured to the spool mount.

11. The fiber distribution system of claim 7, further comprising a fastener for securing the spool lock to the spool mount; and
wherein the fastener is selectively movable between an untightened position in which the spool lock is in an unlocked state and a tightened position in which the spool lock is in a locked state.

12. (canceled)

13. The fiber distribution system of claim 1, further comprising at least one cable management bracket.

14. (canceled)

15. The fiber distribution system of claim 13, wherein the at least one cable management bracket is selectively movable between a folded position in which the at least one cable management bracket is flush with the axial end and an unfolded position in which the at least one cable management bracket extends outwardly from the axial end.

16. The fiber distribution system of claim 1, further comprising a spool lock configured inhibit rotation of the base spool when the spool lock coupled to at least one of the base spool or the spool mount.

17. The fiber distribution system of claim 16, wherein the spool lock includes at least one stop member configured to inhibit rotation of the base spool when the stop member abuts the spool mount.

18. A fiber distribution system configured to be secured to a structure and to store a fiber cable, the fiber distribution system comprising:
a spool mount configured to be secured to the structure, the spool mount including a hub configured to extend outwardly from a wall of the structure;
a base spool rotatably received on the hub;
a detachable spool secured to the base spool so that the detachable spool rotates on the hub with the base spool;
a spool lock configured to selectively impede rotation of the base spool; and
wherein the base spool and the detachable spool are configured to receive the fiber cable.

19. The fiber distribution system of claim 18, wherein the detachable spool is selectively removable from the base spool;
wherein an axial thickness of the fiber distribution system with the detachable spool attached is larger than an axial thickness of the fiber distribution system without the detachable spool attached; and
wherein the base spool and the detachable spool are configured to rotate about the hub to unwind the fiber cable from at least one of the detachable spool or the base spool.

20. The fiber distribution system of claim 18, wherein the base spool and the detachable spool rotate about the hub to unwind the fiber cable format least one of the detachable spool or the base spool.

21. (canceled)

22. (canceled)

23. (canceled)

24. (canceled)

25. (canceled)

26. (canceled)

27. (canceled)

28. A fiber distribution system configured to be secured to a structure and to store a fiber cable, the fiber distribution system comprising:
a spool mount configured to be secured to the structure, the spool mount including a hub configured to extend outwardly from a wall of the structure;
a spool rotatably received on the hub; and
a spool lock configured to selectively impede rotation of the spool.

29. (canceled)

30. The fiber distribution system of claim 28, further comprising a retention plate secured to the hub and configured to retain the spool on the hub.

31. (canceled)

32. The fiber distribution system of claim 28, further comprising a DIN rail and a fiber network element configured to be secured to the DIN rail.

33. (canceled)

34. The fiber distribution system of claim 32, wherein the fiber network element is a cassette that is selectively attachable to the spool; and wherein the attachment of the cassette to the spool actuates the spool lock, thereby impeding rotation of the spool.
